(19) United States
(12) Patent Application Publication
(10) Pub. No.: US 2014/0201241 A1
(43) Pub. Date: Jul. 17, 2014

(54) Apparatus for Accepting a Verbal Query to be Executed Against Structured Data

(71) Applicant: EASYASK, Burlington, MA (US)

(72) Inventors: Richard Johnston Wood, Waban, MA (US); Craig Steven Bassin, Santa Barbara, CA (US)

(73) Assignee: EasyAsk, Burlington, MA (US)

(21) Appl. No.: 13/741,883

(22) Filed: Jan. 15, 2013

(51) Int. Cl. G06F 17/30

(52) U.S. Cl. CPC G06F 17/30522
USPC 707/772

(57) ABSTRACT

A computing system for converting natural language spoken queries to a mobile computing device into structured queries to be executed against a structured data store to obtain an answer to the spoken query on the portable computing device is disclosed. The computer executable instructions may comprising instructions for accepting a verbal input, communicating the verbal input to a verbal to text translation application to obtain a text query where the text query is converted into a structured language query, the structured language query is executed against a structured data store, the results from the structured language query are generated, the results are converted into a desired format for the portable computing device and the result are received in the desired format to the portable computing device where the results are displayed in the desired format on the portable computing device.

### BACKGROUND

In the past, querying structured data such as business data stored in a database has been a challenge. Databases require queries in a specific language such as SQL which require special training. Further, the queries may be difficult for end users to understand and create. As a result, user interfaces have been developed to make querying easier for a larger selection of the public.

Most user interfaces have field that may be selected from a drop down box, for example, and desired values for the fields may be specified. The user interface then translated the values selected into structured language queries which are then executed against structured data stores, such as a database. The results are then usually stored and displayed to a user. In addition, creating such queries commonly requires using a personal computer, at least, that is in communication with the structured data.

### SUMMARY

A computing system for converting natural language spoken queries to a mobile computing device into structured queries to be executed against a structured data store to obtain an answer to the spoken query on the portable computing device is disclosed. The computer may be configured according to computer executable instructions including accepting a verbal input from a portable computing device and for communicating the verbal input to a verbal to text translation application to obtain a text query. The text query may be displayed to a user and may be edited, modified or stored for future use by a user using either text or speech or both.

The text query may be converted into a structured language query and structured language query may be executed against a structured data store. The results from the structured language query may be received and the results may be converted into a desired format for the portable computing device based on communications from the computable computing device or previous knowledge. The result may be communicated in the desired format to the portable computing device where the result is displayed in the desired format on the portable computing device. The results may be saved in the memory from future reference, to be communicated to other computing devices or for quick retrieval.

A portable computing device for executing a spoken natural language query against a structured data store to return a result to the portable computing device is also disclosed. The portable computing device may have a processor configured according to computer executable instructions, a memory for storing computer executable instructions, an input/output device and a communication apparatus. The computer executable instructions may comprising instructions for accepting a verbal input, communicating the verbal input to a verbal to text translation application to obtain a text query where the text query is converted into a structured language query, the structured language query is executed against a structured data store, the results from the structured language query are generated, the results are converted into a desired format for the portable computing device and the result are received in the desired format to the portable computing device where the results are displayed in the desired format on the portable computing device.

### BRIEF DESCRIPTION OF THE DRAWINGS

FIG. 1 is a high level illustration of the components of the system;

FIG. 2 is a flowchart of blocks that may be executed by the system;

FIG. 3 is an illustration of a display on a portable computing device asking for input;

FIG. 4 is an illustration of a display on a portable computing device asking for text input;

FIG. 5 is an illustration of a display on a portable computing device requesting voice input;

FIG. 6 is an illustration of the textual translation of a verbal input being displayed to a user;

FIG. 7 is an illustration of the results of a search against structured data based on a natural language spoken input being displayed on the portable computing device;

FIG. 8 is an illustration of additional input actions available on the portable computing device;

FIG. 9 is an illustration of hardware component that may make up the portable computing device; and

FIG. 10 is an illustration of hardware component that may make up the server.

### SPECIFICATION

In the past, querying structured data such as business data stored in a database has been a challenge. Databases require queries in a specific language such as SQL which require special training. Further, the queries may be difficult for end users to understand and create. As a result, user interfaces have been developed to make querying easier for a larger selection of the public.

Most user interfaces have field that may be selected from a drop down box, for example, and desired values for the fields may be specified. The user interface then translated the values selected into structured language queries which are then executed against structured data stores, such as a database. The results are then usually stored and displayed to a user. In addition, creating such queries commonly requires using a personal computer, at least, that is in communication with the structured data.

In the described system, many of the drawbacks of traditional queries to structured data stores are addressed. Initially, queries are spoken in a natural language to a portable computing device such as a smart phone, pda, tablet, laptop or other portable computing device. As the queries are in natural language, no special knowledge is needed to make a query of the structured data. In addition, the query may be made on the portable computing device eliminating the requirement to make the query using a personal computer, or larger computing device.

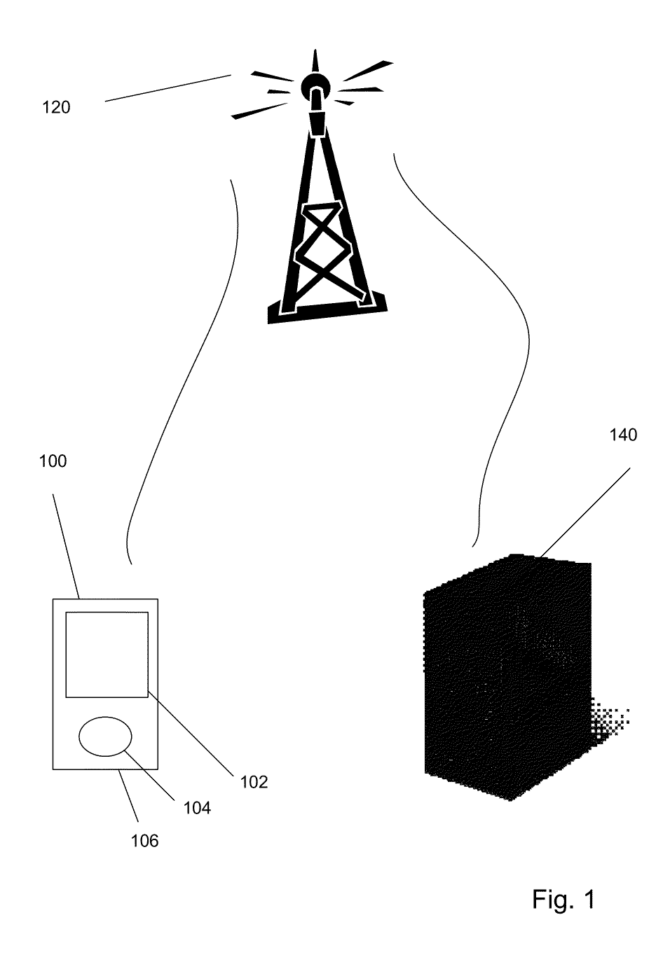

FIG. 1 may be a high level illustration of some of the elements a sample computing system. The computing system may be a dedicated computing device, an dedicated portable computing device, an application on the computing device, an application on the portable computing device or a combination of all of these.

In one embodiment, a portable computing device 100 may be a device that operates using a portable power source such as a battery. The portable computing device 100 may also have a display 102 which may or may not be a touch sensitive display. More specifically, the display 102 may have a capacitance sensor, for example, that may be used to provide input data to the portable computing device 100. In other embodiments, an input pad 104 such as arrows, scroll wheels, keyboards, etc., may be used to provide inputs to the portable computing device 100. In addition, the portable computing device 100 may have a microphone 106 which may accept and store verbal data.

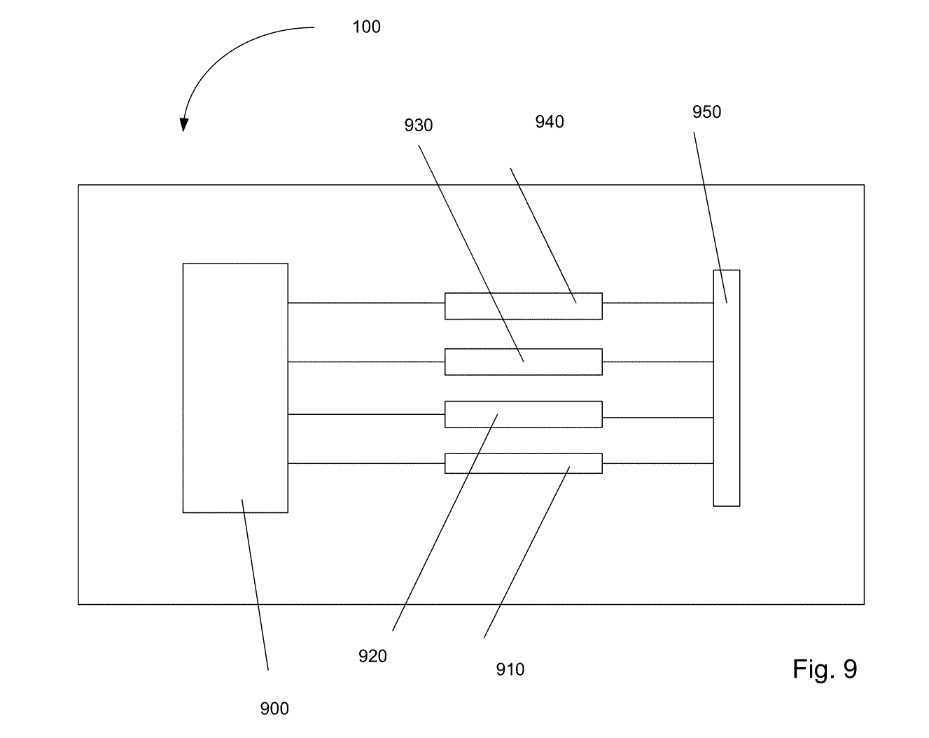

The portable computing device 100 may be able to communicate with a computing device 140. The portable computing device 100 may be able to communicate in a variety of ways. In some embodiments, the communication may be wired such as through an Ethernet cable, a USB cable or RJ6 cable. In other embodiments, the communication may be wireless such as through wifi (802.11 standard), Bluetooth, cellular communication or near field communication devices. The communication may be direct to the computing device 140 or may be through a communication network 120 such as cellular service, through the Internet, through a private network, through Bluetooth, etc. FIG. 9 may be a simplified illustration of the physical elements that make up a portable computing device 100.

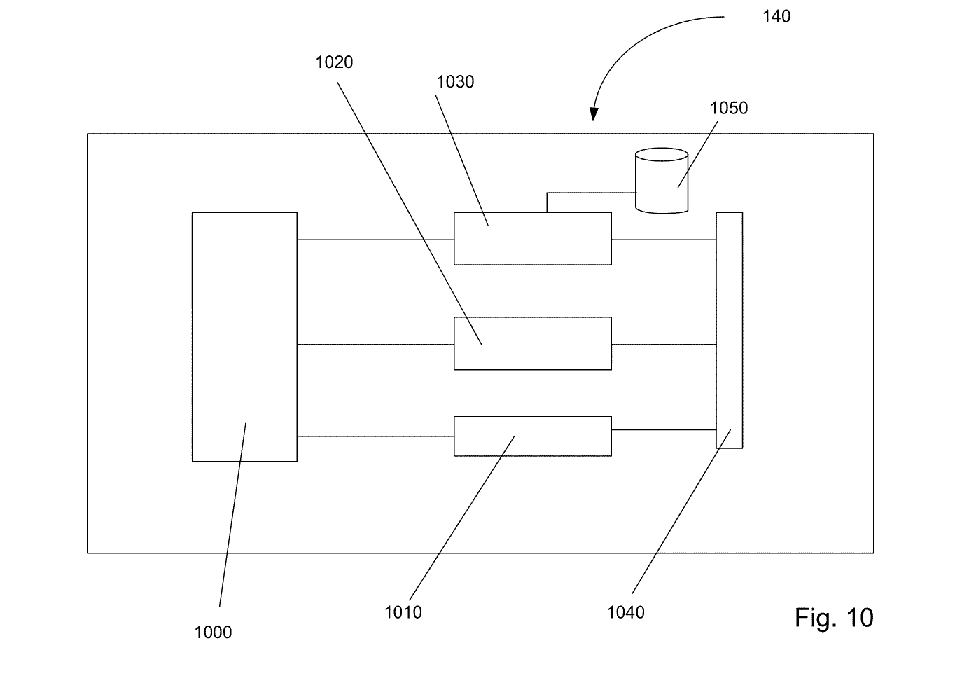

The physical elements that make up the computing device 140 may be further illustrated in FIG. 10. At a high level, the computing device 140 may include a digital storage such as a magnetic disk, an optical disk, flash storage, non-volatile storage, etc. Structured data may be stored in the digital storage such as in a database.

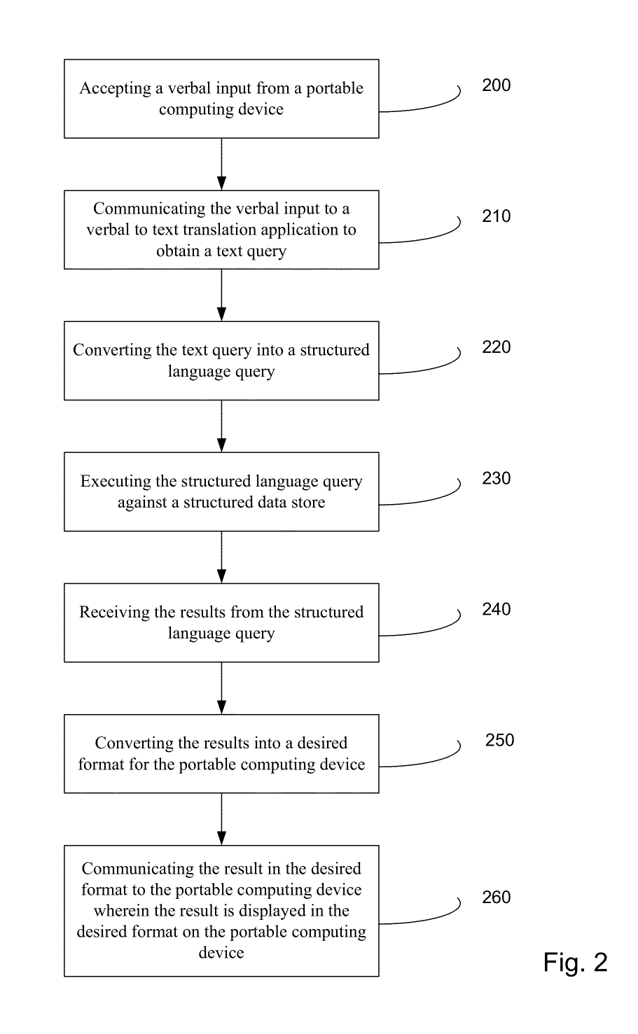

FIG. 2 may illustrate blocks that may be executed by the processor in the computing device 140 for converting speech from into a structured query to a database and providing a result. The processor may be physically configured to execute the block and the memory may be physically configured to store the data needed by the blocks. At block 200, verbal input from a portable computing device may be received. For example, a user may speak into a microphone 104 that is part of or connected to the portable computing device 100. The verbal input may be stored in analog form or digital form. The verbal input may be communicated virtually immediately or may be stored in a memory and communicated in a manner that is efficient in view of the current communication environment. For example, if the portable computing device 100 is outside of wireless communication, the verbal data may be stored in the portable computing device 100 until wireless communication is available. As another example, the verbal data may be stored until the verbal data stops being entered, such as an entire question may be asked.

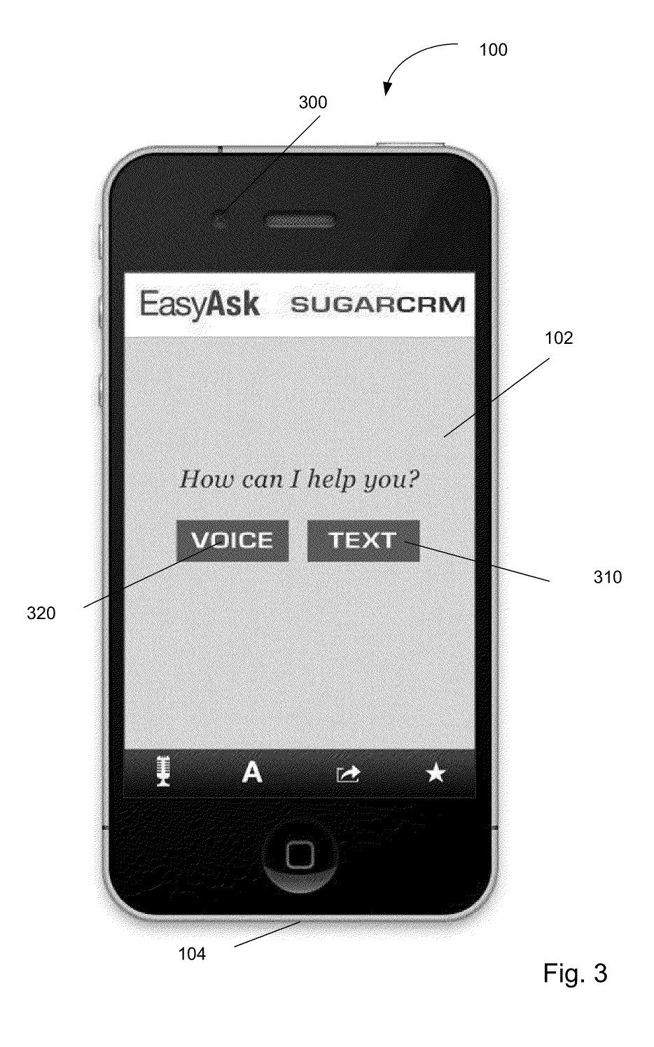

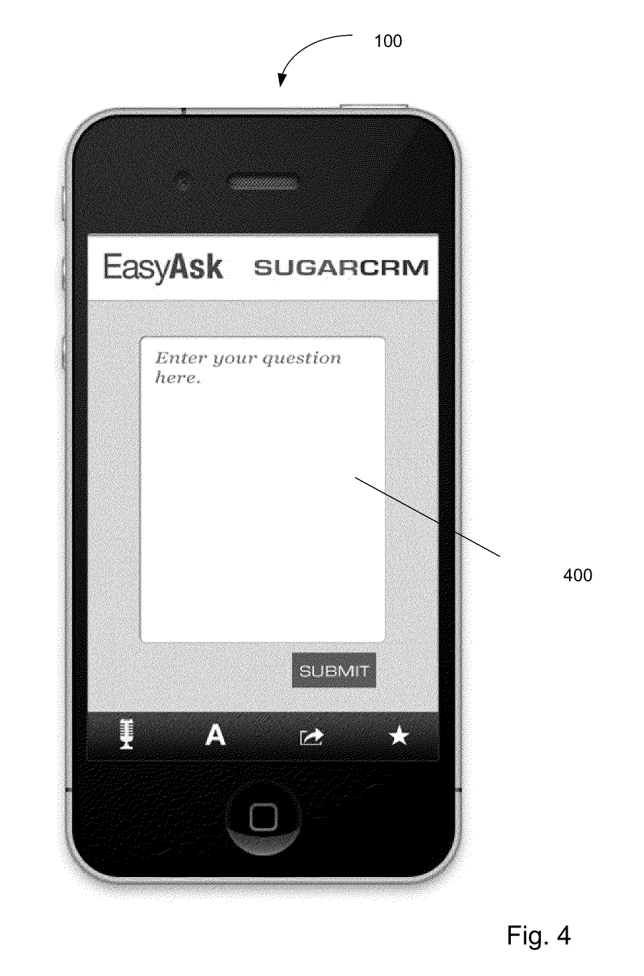

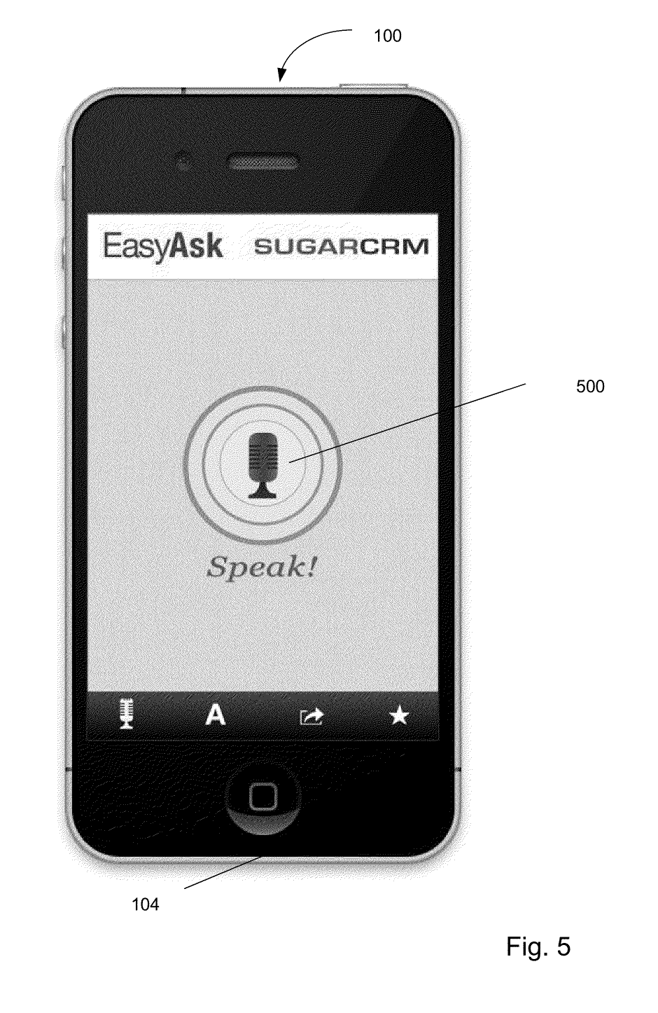

FIG. 3 may be a sample user interface on a portable computing device 100 that a user may use to input verbal data. A user may be given an option to select to use a natural language text input 310 or a natural language voice input 320. If the user selects the text input 310 option, a display such as in FIG. 4 may be displayed where a user may type in a natural language query 400 to a structured data store. If the user selects to use voice or verbal input, a display such as in FIG. 5 may be displayed. A camera 300 may also be used to take images of a user speaking and the images may be used to assisting in “reading lips” or assisting in translating the voice to text. The images may be communicated with the voice data or may be analyzed locally.

At block 210, the verbal input may be communicated to a verbal to text translation application to obtain a text query spoken by the user. A sample application is provided by Nuance Corporation (www.nuance.com) but other vendors and applications are available and would easily work the system. The verbal input may be sampled and stored as digital data. In some embodiments, the verbal to text translation application may execute on the portable computing device 100 and on other embodiments, the digital data may be communicated to the server 140 where the verbal to text translation application may execute. Of course, part of the application may be on the portable computing device 100 and part may be on the server 140 and other arrangements are possible and are contemplated.

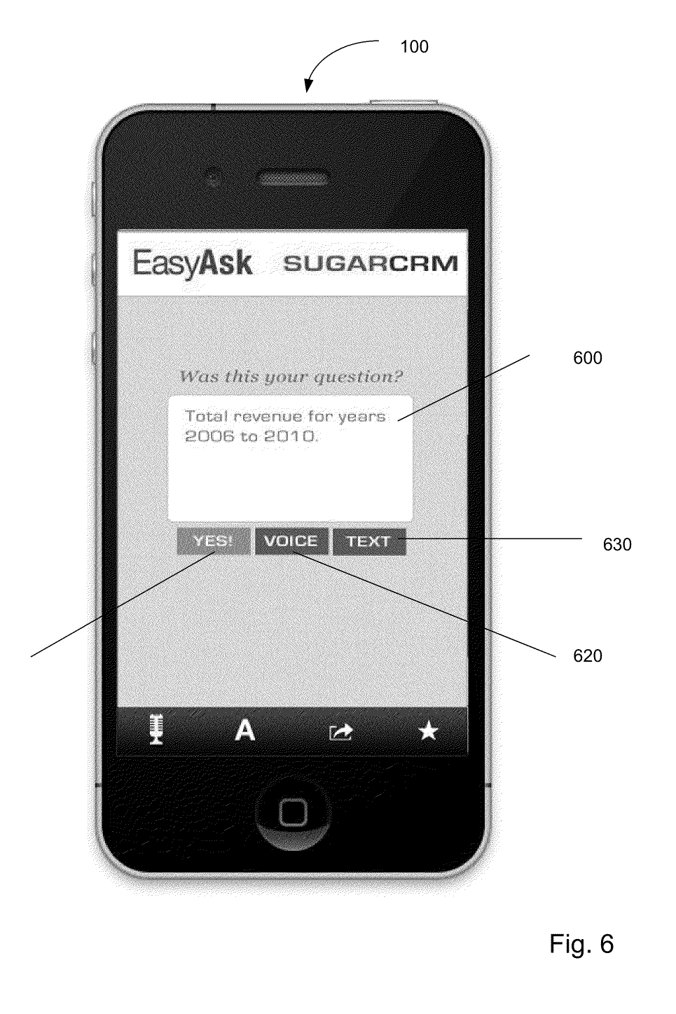

In some embodiments, the text translated from the natural language query may be displayed to a user. FIG. 6 may illustrate a sample display 600 of the translation of a verbal input into natural language text. A user may have some options before the natural language text is subject to further analysis. The user may be able to select that the text is correct 610 and should be further analyzed. The user may also be able to select to modify the text, either by voice 620 or by textual input 630. For example, in the illustration in FIG. 6, a user may use a voice command to change the first year of the query from 2006 to 2007.

The text queries may also be stored in a memory. The memory may be local on the portable computing device 100 or may be stored in the server 140. As the text queries are stored, past queries may be reviewed and selected to be used again and again. For example, a query may be “What are sales to the present date?” As time goes by, the sales hopefully will increase. Thus, this query may be used repeated. Instead of having to repeatedly ask “What are sales to the present date?”, a user may be able to use a shortened form such as “Execute query 1” or the like.

In addition, past text queries may be selected and modified. A command such as “Modify Query 2” may display the query such as in FIG. 6 where a user may be able to use speech or text to modify the query. As an example, the user may be able to narrow a search from 2006-2010 to 2008-2010 by merely changing the 6 in 2006 to an 8. The proposed modification may be approved by a user by a selection or by a voice command on the portable computing device 100. Logically, the modified query may be stored for future use and modification.

If the natural language query is not understood, the system may indicate that the query was not understood. The system may also attempt to make suggestions as to how the query may be modified to be understood. For example, if a query asks for sale for the year 1999 and there are no records for 1999, the system may suggest the oldest year when sales records are available. Similarly, if the query asks about data that is not present such as sale of shoes at hardware store, other, more relevant search terms may be suggested, such as sales of hammers.

At block 220, the natural language text query may be converted into a structured language query. Applications to convert natural language text queries to structured query languages exist and are available such as from EasyAsk (www.easyask.com). Of course, other conversional applications may exist and would likely work in the system. In summary, the natural language query is parsed into parts, the parts are matched to known elements in a database and known requests, and the proper structure query is created. In addition, error checking of the structured query may be used before the structured query is presented to the structured data store.

At block 230, the structured language query may be executed against a structured data store such as a database in order to determine the answer to the query. The database likely will be in the server 140 but in some instance, may be stored in the portable computing device 100. The server 140 may also be thought of reside in a virtual cloud, wherein many computing devices are accessible, possibly including devices around the world, through a network connection. The database may be a rational database, a structured database or any modern database. In addition, the database may be used as part of a customer relationship management system (CRM), an enterprise resource planning application (ERP), an accounting system, a time management system, or any other computing system that stores data in a structure format.

At block 240, the results from the structured language query may be received such that the answer may be provided to the portable computing device 100. The results may be the output of the query against the structured data store. The output may then be modified to be displayed in a desired way on the portable computing device 100. In addition, the results may be modified into a form that the user desires. For example, if the user desires a pie chart, a pie chart may be created and if the user desires a text answer, the appropriate text may be created. The results may be stored in a memory such that if the same query is executed against the structured data in the near future, the answer will be readily available.

At block 250, the results may be converted into a desired format for the portable computing device. For example, characteristics of the portable computing device may be determined and used to select the desired format for the portable computing device 100. As an example, a portable computing device 100 that is an Apple iPhone® may not support results displayed using Flash display technology. Similarly, an older phone may not be able to display more recent HTML code. Similarly, not all portable computing devices 100 have the same display height and width and it would make little sense to deliver results that do not properly fit on a display 102. In some embodiments, the portable computing device 100 is queried for its display characteristics or in other embodiments, the portable computing device 100 display type is known from registration data or other data communicated by the portable computing device 100.

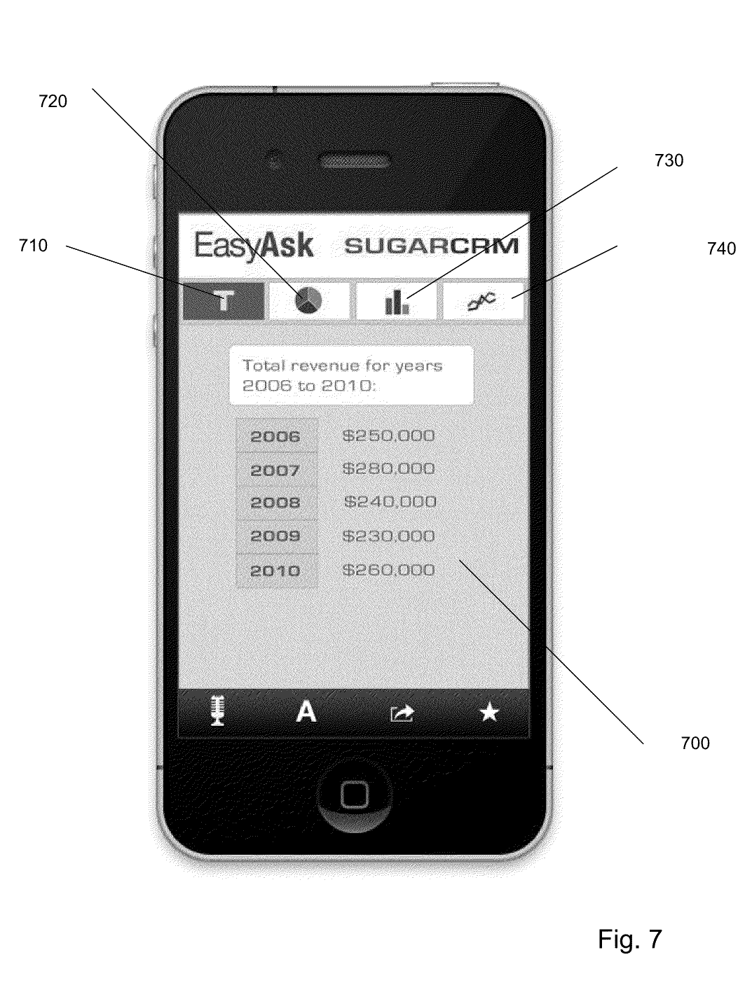

At block 260, the result may be communicated in the desired format to the portable computing device 100 where the result is displayed in the desired format on the portable computing device 100. FIG. 7 may be an illustration of the results 700 being displayed in the desired format. The format may be changed by making a selection such as text 710, pie chart 720, bar chart 730 or line graph 740. Of course, other displays are possible depending on the results 700 and the query.

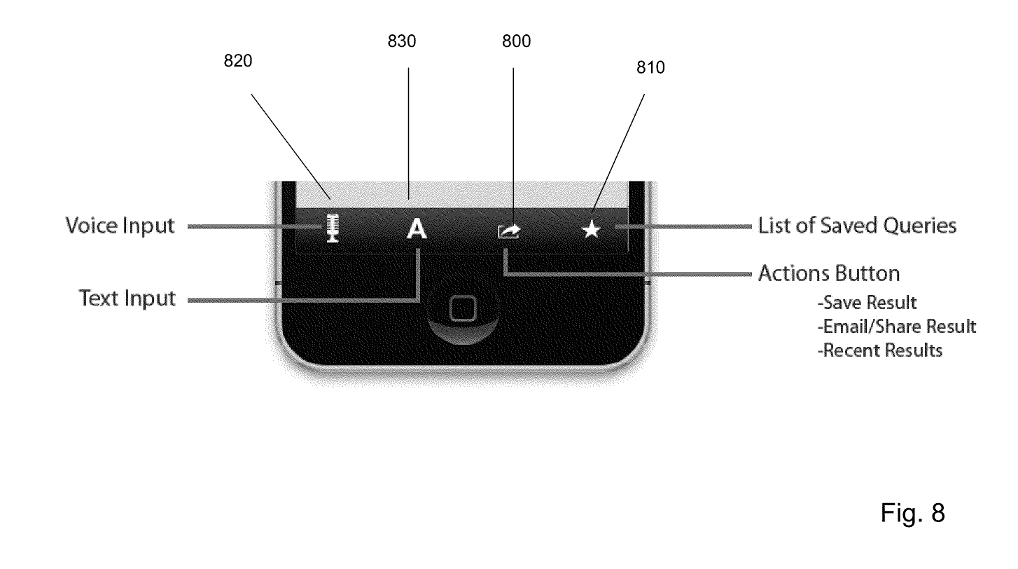

The results may be stored in the memory either locally on the portable computing device 100 or remotely on the server 140. In this way, the results may be quickly retrieved if the same query is issued against the same structured data. FIG. 8 may illustrate the use of inputs on the portable computing device 100 to further review results 700. For example, the result 700 may be communicated to an additional computing device 800, such as an email attachment or through a file share using a network cloud, for example. In addition, the past results 700 stored in the memory may be quickly selected 810 to be retrieved and reviewed without having to re-access the structured data store. In addition, the results 700 may raise further questions and queries. Additional queries may be entered by selecting to enter queries verbally 820 or through text 830.

FIG. 9 may be a sample portable computing device 100 that is physically configured according to be part of the system. The portable computing device 100 may have a processor 900 that is physically configured according to computer executable instructions. It may have a portable power supply 910 such as a battery which may be rechargeable. It may also have a sound and video module 920 which assists in displaying video and sound and may turn off when not in use to conserve power and battery life. The portable computing device 100 may also have volatile memory 930 and non-volatile memory 940. There also may be an input/output bus 950 that shuttles data to and from the various user input devices such as the microphone 102, the inputs, etc. It also may control of communicating with the networks, either through wireless or wired devices. Of course, this is just one embodiment of the portable computing device 100 and the number and types of portable computing devices 100 is limited only by the imagination.

FIG. 10 may be a sample server 140 that is physically configured according to be part of the system. The server 140 may have a processor 1000 that is physically configured according to computer executable instructions. It may also have a sound and video module 1010 which assists in displaying video and sound and may turn off when not in use to conserve power and battery life. The server 140 may also have volatile memory 1020 and non-volatile memory 1030. The database 1050 may be stored in the memory 1020 or 1030 or may be separate. The database 1050 may also be part of a cloud of computing device 140 and may be stored in a distributed manner across a plurality of computing devices 140. There also may be an input/output bus 1040 that shuttles data to and from the various user input devices such as the microphone, the inputs 102, etc. The input/output bus 1040 also may control of communicating with the networks, either through wireless or wired devices. Of course, this is just one embodiment of the server 140 and the number and types of portable computing devices 140 is limited only by the imagination.

As an example, a user may have a smart phone which may be one form of a portable computing device 100. The smart phone 100 may have an application loaded that provides a user interface such as the user interface in FIG. 3. The user may select to enter the query either using text using an interface such as in FIG. 4 or voice using an interface as in FIG. 5. If the user selects voice, a question may be spoken. The question may be a natural language question, such as how one person would ask another person, and does not require knowledge of computer languages or database terms. In some embodiments, the voice is converted to text on the phone and in other embodiments, the voice is communicated to a remote server 140, such a network of server 140 in a network cloud, where the voice is converted to text. The text may then be displayed to the user on the smart phone 100 where the user may modify the text or approve the text to be used as the query. Once the text of the query is approved, it may be stored in a memory where it may be reviewed or modified in the future for similar queries.

The natural language text may then be analyzed by an application that transforms the natural language text to a structured query that is appropriate for the structured data store. In some embodiments, the application may be stored and execute locally on the portable computing device 100 and in other embodiments, the application may be stored and operate in the network cloud such as on a server 140 accessible through the communication device.

Once the structured language query is created, it is executed against the structured data store to obtain the desire answer. The desired answer may be modified as desired by the user. For example, the user may desire a bar chart and the answer may be modified to appear as a bar chart. In other examples, the desired answer may simply be a number. Further, the answer may be modified to fit the portable computing device 100. As an example, the display of some portable computing devices 100 may be larger than others and the result may be modified to fit the portable computing device 100. Again, the modification of the result may be accomplished locally on the portable computing device 100 or remote on a server 140. The result may then be displayed on the portable computing device 100. In addition, the result may be emailed or otherwise electronically communicated to additional computing devices. Further, the results may be stored in a memory for quick recall for related queries in the future.

Of course, there are additional embodiments possible and this specification describes some embodiments. Describing all the possible embodiments would be virtually impossible if not impractical. Thus obvious variants of the described and claimed device are possible and are intended to be covered by the claims.

1. A computing system comprising:
a processor configured according to computer executable instructions,
a memory for storing computer executable instructions,
an input/output device; and
a communication apparatus;
the computer executable instructions comprising instructions for converting natural language speech into a structured query to a database and providing a result, wherein the computer executable instructions further comprise instructions for:
Accepting a verbal input from a portable computing device;
Communicating the verbal input to a verbal to text translation application to obtain a text query;
Converting the text query into a structured language query;
Executing the structured language query against a structured data store;
Receiving the results from the structured language query;
Converting the results into a desired format for the portable computing device;
Communicating the result in the desired format to the portable computing device wherein the result is displayed in the desired format on the portable computing device.

2. The computing device of claim 1, further comprising computer executable code for displaying the text query to a user.

3. The computing device of claim 1, further comprising computer executable code for allowing the text query to be modified.

4. The computing device of claim 3, further comprising computer executable code for accepting modification to the text query using text or verbal inputs.

5. The computing device of claim 1, further comprising computer executable code for determining characteristic of the portable computing device and using the characteristics to select the desired format.

6. The computing device of claim 1, further comprising computer executable code for storing the text query for future availability.

7. The computing device of claim 1, further comprising computer executable code for allowing the stored text queries to be reviewed and selected.

8. The computing device of claim 1, further comprising computer executable code for allowing the stored text queries to be modified and stored/executed.

9. The computing device of claim 1, further comprising computer executable code for saving the result in the memory.

10. The computing device of claim 1, further comprising computer executable code for communicating the result to an additional computing device.

11. The computing device of claim 1, further comprising computer executable code for reviewing past results stored in the memory.

12. A portable computing device for executing a spoken natural language query against a structured data store to return a result comprising:
a processor configured according to computer executable instructions,
a memory for storing computer executable instructions,
an input/output device; and
a communication apparatus;
the computer executable instructions comprising instructions for converting natural language speech into a structured query to a database and providing a result, wherein the computer executable instructions further comprise instructions for:
Accepting a verbal input;
Communicating the verbal input to a verbal to text translation application to obtain a text query wherein:
the text query is converted into a structured language query;
the structured language query is executed against a structured data store;
the results from the structured language query are generated;
the results are converted into a desired format for the portable computing device;
Receiving the result in the desired format to the portable computing device wherein the result is displayed in the desired format on the portable computing device.
